(19) United States
(12) Patent Application Publication
(10) Pub. No.: US 2022/0372378 A1
(43) Pub. Date: Nov. 24, 2022

(54) CATALYST AND PROCESS TO UPGRADE HEAVY OIL

(71) Applicant: Saudi Arabian Oil Company, Dhahran (SA)

(72) Inventor: Ki-Hyouk Choi, Dhahran (SA)

(73) Assignee: Saudi Arabian Oil Company, Dhahran (SA)

(21) Appl. No.: 17/328,781

(22) Filed: May 24, 2021

(51) Int. Cl. C10G 11/02; C10G 45/26; C10G 47/26; C10G 47/32

(52) U.S. Cl. CPC C10G 11/02; C10G 45/26; C10G 47/26; C10G 47/32; C10G 2300/107; C10G 2300/805; C10G 2300/202; C10G 2300/205; C10G 2300/308; C10G 2300/708; C10G 2300/703; C10G 2300/4037; C10G 2300/4006; C10G 2300/4012

(57) ABSTRACT

A process for treating a feed oil in the presence of in situ produced catalyst particles comprising the steps of mixing the supercritical water feed with the pressurized precursor solution in a catalyst mixer to produce a supercritical water stream; withdrawing the supercritical water stream to a process line, where the catalyst precursor is converted to catalyst particles in the process line; mixing the supercritical water stream and the hot oil stream in the mixer to produce a mixed stream; introducing the mixed stream to a reactor; processing the heavy oil in the reactor in the presence of the catalyst particles to produce a reactor effluent; reducing a temperature of the reactor effluent to produce a cooled effluent; reducing a pressure of the cooled effluent to produce a depressurized effluent; and separating the depressurized effluent to produce a product gas, a product oil, and a product water.

### TECHNICAL FIELD

Disclosed are methods for upgrading oil. Specifically, disclosed are methods and systems for upgrading heavy oil with catalysts produced in situ.

### BACKGROUND

Although supercritical water provides beneficial impact on the thermal cracking of heavy oil, the extent of upgrading and desulfurization is limited by reaction temperature, residence time, and scarcity of hydrogen. The temperature cannot go very high because of immediate coke formation at high temperatures in spite of the cage effect of supercritical water, such high temperatures practically limited to about 450° C. Limited temperature means limited kinetics. Residence time is also limited to less than 60 minutes because long residence times cause coke formation even at lower temperatures. Limited residence time also means limited kinetics. Most of the reactions occurring with heavy oil under supercritical water are thermal cracking reactions, mediated by radical chain reaction. Due to limited amounts of available hydrogen in the heavy oil feed, thermal cracking produces unstable intermediates such as unsaturated hydrocarbons, which may produce solid coke. Even with an external supply of hydrogen gas, molecular hydrogen is not active in reacting with hydrocarbons without catalysts.

Catalysts could overcome the limitations of the supercritical water process by contributing catalytic reaction routes in addition to main thermal cracking routes for upgrading. Also, catalysts can serve as activation centers for molecular hydrogen. Two types of catalysts to consider for supercritical water process are homogeneous catalysts and heterogeneous catalysts. Homogeneous catalysts, defined as catalysts soluble in a reaction medium, do not tend to survive in supercritical water conditions and easily ended up forming aggregates of insoluble materials through decomposition. Heterogeneous catalysts, defined as catalysts in a separate phase from reactants and products, exhibit relatively superior stability under supercritical water conditions. Heterogeneous catalysts can be deployed in several types of reactors, including fixed bed, ebullated-bed, and fluidized-bed reactors.

However, these reactors are not readily applicable to supercritical water-heavy oil systems. First, because large molecules in the heavy oil have limited access to active sites in the catalyst pore structure due to their large kinematic diameters. In fixed bed reactors, the molecules must approach the active sites in the pore structure of the catalyst through diffusion barriers. Second, pressure drop can develop quickly through the catalyst bed, which results in undesired shut-down of the process. Third, ebullated-bed and fluidized-bed reactors have complicated flow paths which can be difficult to adapt to high pressure and high temperature reactor systems as would be required in a supercritical water process.

Additionally, it must be pointed out that heterogeneous catalysts may not have sufficient stability in supercritical water to exhibit activity for long periods of time, such as for a year or longer. Thus, requiring regeneration at frequent periods.

Slurry-bed reactors can overcome the limitations of fixed bed, ebullated bed and fluidized bed reactors. In a slurry-bed reactor, catalysts are continuously discharged from and injected into the reactor. Thus, the catalysts do not experience long exposure to harsh conditions of supercritical water and a slurry-bed reactor continuously has fresh catalyst, although some amount of catalyst can be gradually deactivated through the reactor. Due to the well-dispersed state of catalyst and fine size of catalyst particles in the slurry-bed reactor, large molecules in the heavy oil can access active sites relatively easily and without diffusion barriers. Slurry-bed reactors have been employed for hydrocracking of residue fraction. However, slurry-bed reactors have their own set of requirements.

The catalysts must be small in size to flow with fluids smoothly and to allow easy access of reactant molecules to actives sites on the catalyst particles. This requirement limits the concentration of catalyst (wt of catalyst/wt of reactor internal fluid) in the slurry-bed reactors, which limits the kinetics. The catalysts must be well dispersed in the fluid for exerting catalytic effect to the entire volume of reactants. Finally, the catalysts must be easily separated from the products.

### SUMMARY

Disclosed are methods for upgrading oil. Specifically, disclosed are methods and systems for upgrading heavy oil with catalysts produced in situ.

In a first aspect, a process for treating a feed oil in the presence of in situ produced catalyst particles is provided. The process includes the steps of increasing a pressure of a catalyst precursor solution in a precursor pump to produce a pressurized precursor solution, increasing a pressure of a feed water in a water pump to produce a pressurized feed water, increasing a temperature of the pressurized feed water in a water preheater to produce a supercritical water feed, mixing the supercritical water feed with the pressurized precursor solution in a catalyst mixer to produce a supercritical water stream, where the supercritical water stream is at a temperature between 374° C. and 500° C. and a pressure between 22 MPa and 35 MPa, withdrawing the supercritical water stream to a process line connecting the catalyst mixer to a mixer, where the catalyst precursor is converted to catalyst particles in the process line such that the supercritical water stream includes water at supercritical conditions and the catalyst particles, where the catalyst particles include metal oxides, where the Reynolds number of the supercritical water stream in the process line is greater than 6,000, where the residence time in the process line is between 0.05 minutes and 10 minutes, increasing a pressure of the feed oil in an oil pump to produce a pressurized oil stream, where the feed oil includes heavy oil, increasing a temperature of the pressurized oil stream to produce a hot oil stream, mixing the supercritical water stream and the hot oil stream in the mixer to produce a mixed stream, where the mass flow ratio of the supercritical water stream to the hot oil stream is in the range of 0.1:1 and 10:1, where the mass ratio of metal oxide to the hot oil stream is in the range of 0.00005:1 and 0.005:1, introducing the mixed stream to a reactor, where the reactor is operated at a temperature between 380° C. and 500° C. and a pressure between 22 MPa and 35 MPa, processing the heavy oil in the reactor in the presence of the catalyst particles to produce a reactor effluent, where the catalyst particles catalyze upgrading reactions of the heavy oil, reducing a temperature of the reactor effluent in a cooling unit to produce a cooled effluent, reducing a pressure of the cooled effluent in a pressure let-down device to produce a depressurized effluent, and separating the depressurized effluent in a separator unit to produce a product gas, a product oil, and a product water.

In certain aspects, the precursor catalyst includes a cation and an anion. In certain aspects, the cation is selected from the group consisting of transition metals from periods 4 to 6, groups 4 to 12 of the periodic table, cerium, and combinations of the same. In certain aspects, the anion is selected from the group consisting of sulfates, chlorides, acetates, acetyl acetonate, formates and combinations of the same. In certain aspects, the process further includes the steps of introducing the product oil to a distillation column, separating the product oil in the distillation column to produce a bottom fraction and an upgraded oil product, where the bottom fraction includes catalyst particles, introducing the bottom fraction to a bottoms separation unit, and separating the catalyst particles in the bottoms separation unit to produce separated catalyst and a bottoms fraction stream.

In a second aspect, a system for treating a heavy oil in the presence of in situ produced catalyst particles is provided. The system includes a precursor pump, the precursor pump configured to increase a pressure of a catalyst precursor solution to produce a pressurized precursor solution, a water pump configured to increase a pressure of a water feed to produce a pressurized feed water, a water preheater fluidly connected to the water pump, the water preheater configured to increase a temperature of the pressurized feed water to produce a supercritical water feed, a catalyst mixer fluidly connected to the precursor pump and the water preheater, the catalyst mixer configured to mix the supercritical water feed with the pressurized precursor solution in to produce a supercritical water stream, where the supercritical water stream is at a temperature between 374° C. and 500° C. and a pressure between 22 MPa and 35 MPa, a process line connecting the catalyst mixer to a mixer, where the catalyst precursor is converted to catalyst particles in the process line such that the supercritical water stream includes water at supercritical conditions and the catalyst particles, where the catalyst particles include metal oxides, where the Reynolds number of the supercritical water stream in the process line is greater than 6,000, where the residence time in the process line is between 0.05 minutes and 10 minutes, the mixer configured to the supercritical water stream and a hot oil stream in the mixer to produce a mixed stream, where the mass flow ratio of the supercritical water stream to the hot oil stream is in the range of 0.1:1 and 10:1, where the mass ratio of metal oxide to the hot oil stream is in the range of 0.00005:1 and 0.005:1, where the hot oil stream includes the heavy oil, a reactor fluidly connected to the mixer, the reactor configured to maintain upgrading reactions of the heavy oil to produce a reactor effluent, where the reactor is operated at a temperature between 380° C. and 500° C. and a pressure between 22 MPa and 35 MPa, where the catalyst particles catalyze the upgrading reactions of the heavy oil, a cooling unit fluidly connected to the reactor, the cooling unit configured to reduce a temperature of the reactor effluent to produce a cooled effluent, a pressure let-down device fluidly connected to the cooling unit, the pressure let-down device configured to reduce a pressure of the cooled effluent to produce a depressurized effluent, and a separator unit fluidly connected to the pressure let-down device, the separator unit configured to separate the depressurized effluent to produce a product gas, a product oil, and a product water.

In certain aspects, the precursor catalyst includes a cation and an anion. In certain aspects, the cation is selected from the group consisting of transition metals from periods 4 to 6, groups 4 to 12 of the periodic table, cerium, and combinations of the same. In certain aspects, the anion is selected from the group consisting of sulfates, chlorides, acetates, acetyl acetonate, formates and combinations of the same. In certain aspects, the system further includes a distillation column fluidly connected to the separator unit, the distillation column configured to separate the product oil to produce a bottom fraction and an upgraded oil product, where the bottom fraction includes catalyst particles, and a bottoms separation unit fluidly connected to the distillation column, the bottoms separation unit configured to separate the catalyst particles to produce separated catalyst and a bottoms fraction stream. In certain aspects, further includes an oil pump, the oil pump configured to increase a pressure of a feed oil to produce a pressurized oil stream, where the feed oil includes the heavy oil, and an oil preheater fluidly connected to the oil pump, the oil preheater configured to increase a temperature of the pressurized oil stream to produce the hot oil stream, where the hot oil stream is at a temperature in the range between 100° C. and 250° C. and a pressure between 22 MPa and 35 MPa.

In a third aspect, a process for treating a feed oil in the presence of in situ produced catalyst particles is provided. The process includes the steps of mixing a feed water with a catalyst precursor solution in a catalyst mixer to produce a metal-containing water stream, where the catalyst precursor solution includes a catalyst precursor dissolved in liquid water, increasing a pressure of the metal-containing water stream in a water pump to produce a pressurized water stream, increasing a temperature of the pressurized water stream in a water preheater to produce a supercritical water stream, where the supercritical water stream is at a temperature between 374° C. and 500° C. and a pressure between 22 MPa and 35 MPa, where the catalyst precursor is converted to catalyst particles in the water preheater such that the supercritical water stream includes water at supercritical conditions and the catalyst particles, where the catalyst particles include metal oxides, where the Reynolds number of the pressurized water stream is greater than 6,000, increasing a pressure of the feed oil in an oil pump to produce a pressurized oil stream, where the feed oil includes heavy oil, increasing a temperature of the pressurized oil stream to produce a hot oil stream, mixing the supercritical water stream and the hot oil stream in a mixer to produce a mixed stream, where the mass flow ratio of the supercritical water stream to the hot oil stream is in the range of 0.1:1 and 10:1, where the mass ratio of metal oxide to the hot oil stream is in the range of 0.00005:1 and 0.005:1, introducing the mixed stream to a reactor, where the reactor is operated at a temperature between 380° C. and 500° C. and a pressure between 22 MPa and 35 MPa, processing the heavy oil in the reactor in the presence of the catalyst particles to produce a reactor effluent, where the catalyst particles catalyze upgrading reactions of the heavy oil, reducing a temperature of the reactor effluent in a cooling unit to produce a cooled effluent, reducing a pressure of the cooled effluent in a pressure let-down device to produce a depressurized effluent, and separating the depressurized effluent in a separator unit to produce a product gas, a product oil, and a product water.

In certain aspects, the precursor catalyst includes a cation and an anion. In certain aspects, the cation is selected from the group consisting of transition metals from periods 4 to 6, groups 4 to 12 of the periodic table, cerium, and combinations of the same. In certain aspects, the anion is selected from the group consisting of sulfates, chlorides, acetates, acetyl acetonate, formates and combinations of the same. In certain aspects, the process further includes the step of introducing the product oil to a distillation column, separating the product oil in the distillation column to produce a bottom fraction and an upgraded oil product, where the bottom fraction includes catalyst particles, introducing the bottom fraction to a bottoms separation unit, and separating the catalyst particles in the bottoms separation unit to produce separated catalyst and a bottoms fraction stream. In certain aspects, an internal fluid in process lines connecting the water preheater, the mixer, and the reactor have a Reynolds number greater than 6,000.

### BRIEF DESCRIPTION OF THE DRAWINGS

These and other features, aspects, and advantages of the scope will become better understood with regard to the following descriptions, claims, and accompanying drawings. It is to be noted, however, that the drawings illustrate only several embodiments and are therefore not to be considered limiting of the scope as it can admit to other equally effective embodiments.

FIG. 1 provides a process diagram of an embodiment of the system and process for upgrading heavy oil with in situ produced catalyst particles.

FIG. 2 provides a process diagram of an embodiment of the system and process for upgrading heavy oil with in situ produced catalyst particles.

FIG. 3 provides a process diagram of an embodiment of the system and process for upgrading heavy oil with in situ produced catalyst particles.

FIG. 4 provides a process diagram of an embodiment of the system and process for upgrading heavy oil with in situ produced catalyst particles.

FIG. 5 provides a graphical representation of the relationship between pressure and temperature on the ionic product of supercritical water.

In the accompanying Figures, similar components or features, or both, may have a similar reference label.

### DETAILED DESCRIPTION

While the scope of the apparatus and method will be described with several embodiments, it is understood that one of ordinary skill in the relevant art will appreciate that many examples, variations and alterations to the apparatus and methods described here are within the scope and spirit of the embodiments.

Accordingly, the embodiments described are set forth without any loss of generality, and without imposing limitations, on the embodiments. Those of skill in the art understand that the scope includes all possible combinations and uses of particular features described in the specification.

The system and methods described integrate the synthesis of catalyst particles with the upgrading of heavy oil in supercritical water. More specifically, the system and methods employ an in situ method to produce metal oxide catalysts with the aid of supercritical water, which then is a reaction medium for upgrading and desulfurization reactions of heavy oil.

Advantageously, the system and process to upgrade heavy oil with in situ produced catalyst can improve the upgrading and desulfurization performance of supercritical water process by employing catalysts. Advantageously and unexpectedly, the disclosed methods produce in situ catalysts used for exerting catalytic effect for upgrading and desulfurization of heavy oil.

Advantageously, in situ produced catalyst particles do not suffer disadvantages of ex situ catalysts. Ex situ produced nano-sized or submicron-sized inorganic powders tend to form aggregates from static or chemical interaction in air or water during storage or before use. Once aggregated, it is difficult to disperse such powdered catalyst to primary particle levels. Aggregated particles, in spite of no change in chemical structure, show lower catalytic activity due to lowered surface area.

Advantageously and unexpectedly, using catalyst particles immediately after synthesis without a change in operating conditions reduces or eliminates the aggregations of the catalyst particles.

As used throughout “residence time” is calculated by assuming the density of the internal fluid in a vessel, pipe, tubular, or other process unit is the same as pure water at the operating conditions of the vessel, pipe, tubular, or other process unit.

As used throughout “Reynolds number” is calculated by assuming the density of the internal fluid in a vessel, pipe, tubular, or other process unit is the same as pure water at the operating conditions of the vessel, pipe, tubular, or other process unit.

As used throughout, “bottom fraction” refers to the fraction of an oil stream having a boiling point greater than 650 F, alternately greater than 1050 F, alternately greater than 1200 F, and alternately between 1050 F and 1200 F.

As used throughout, “external supply of hydrogen” refers to the addition of hydrogen to the feed to the reactor or to the reactor itself. For example, a reactor in the absence of an external supply of hydrogen means that the feed to the reactor and the reactor are in the absence of added hydrogen, gas (H₂) or liquid, such that no hydrogen (in the form H₂) is a feed or a part of a feed to the reactor.

As used throughout, “ex situ catalyst” refers to catalyst prepared external to the upgrading process and added to one of the fluid streams.

As used throughout, “supercritical water” refers to water at a temperature at or greater than the critical temperature of water and at a pressure at or greater than the critical pressure of water. The critical temperature of water is 373.946° C. The critical pressure of water is 22.06 megapascals (MPa). It is known in the art that hydrocarbon reactions in supercritical water upgrade heavy oil and crude oil containing sulfur compounds to produce products that have lighter fractions. Supercritical water has unique properties making it suitable for use as a petroleum reaction medium where the reaction objectives can include conversion reactions, desulfurization reactions denitrogenation reactions, and demetallization reactions. Advantageously, at supercritical conditions water acts as both a hydrogen source and a solvent (diluent) in conversion reactions, desulfurization reactions and demetallization reactions and a catalyst is not needed. Hydrogen from the water molecules is transferred to the hydrocarbons through direct transfer or through indirect transfer, such as the water-gas shift reaction. In the water-gas shift reaction, carbon monoxide and water react to produce carbon dioxide and hydrogen. The hydrogen can be transferred to hydrocarbons in desulfurization reactions, demetallization reactions, denitrogenation reactions, and combinations.

As used throughout, “coke” refers to the toluene insoluble material present in petroleum.

As used throughout, “cracking” refers to the breaking of hydrocarbons into smaller ones containing few carbon atoms due to the breaking of carbon-carbon bonds.

As used throughout, “upgrade” or “upgrading” means one or all of increasing API gravity, decreasing the amount of heteroatoms, including sulfur atoms, nitrogen atoms, metal atoms, and oxygen atoms, decreasing the amount of asphaltene, increasing the middle distillate yield, decreasing the viscosity, and combinations of the same, in a process outlet stream relative to the process feed stream. One of skill in the art understands that upgrade can have a relative meaning such that a stream can be upgraded in comparison to another stream, but can still contain undesirable components such as heteroatoms.

As used throughout, “upgrading reactions” refers to reactions that can upgrade a hydrocarbon stream including cracking, isomerization, oligomerization, dealkylation, dimerization, aromatization, cyclization, desulfurization, denitrogenation, deasphalting, demetallization, and combinations of the same.

It is known in the art that hydrocarbon reactions in supercritical water upgrade heavy oil and crude oil containing sulfur compounds to produce products that have lighter fractions. Supercritical water has unique properties making it suitable for use as a petroleum reaction medium where the reaction objectives can include conversion reactions, desulfurization reactions denitrogenation reactions, and demetallization reactions. Supercritical water is water at a temperature at or greater than the critical temperature of water and at a pressure at or greater than the critical pressure of water. The critical temperature of water is 373.946° C. The critical pressure of water is 22.06 megapascals (MPa). Advantageously, at supercritical conditions water acts as both a hydrogen source and a solvent (diluent) in conversion reactions, desulfurization reactions and demetallization reactions and a catalyst is not needed. Hydrogen from the water molecules is transferred to the hydrocarbons through direct transfer or through indirect transfer, such as the water-gas shift reaction. In the water-gas shift reaction, carbon monoxide and water react to produce carbon dioxide and hydrogen. The hydrogen can be transferred to hydrocarbons in desulfurization reactions, demetallization reactions, denitrogenation reactions, and combinations of the same. The hydrogen can also reduce the olefin content. The production of an internal supply of hydrogen can reduce coke formation.

Without being bound to a particular theory, it is understood that the basic reaction mechanism of supercritical water mediated petroleum processes is the same as a free radical reaction mechanism. Radical reactions include initiation, propagation, and termination steps. With hydrocarbons, initiation is the most difficult step and conversion in supercritical water can be limited due to the high activation energy required for initiation. Initiation requires the breaking of chemical bonds. The bond energy of carbon-carbon bonds is about 350 kJ/mol, while the bond energy of carbon-hydrogen is about 420 kJ/mol. Due to the chemical bond energies, carbon-carbon bonds and carbon-hydrogen bonds do not break easily at the temperatures in a supercritical water process, 380° C. to 450° C., without catalyst or radical initiators. In contrast, aliphatic carbon-sulfur bonds have a bond energy of about 250 kJ/mol. The aliphatic carbon-sulfur bond, such as in thiols, sulfide, and disulfides, has a lower bond energy than the aromatic carbon-sulfur bond.

Thermal energy creates radicals through chemical bond breakage. Supercritical water creates a “cage effect” by surrounding the radicals. The radicals surrounded by water molecules cannot react easily with each other, and thus, intermolecular reactions that contribute to coke formation are suppressed. The cage effect suppresses coke formation by limiting inter-radical reactions. Supercritical water, having a low dielectric constant compared to liquid phase water, dissolves hydrocarbons and surrounds radicals to prevent the inter-radical reaction, which is the termination reaction resulting in condensation (dimerization or polymerization). Moreover, the dielectric constant of supercritical water can be tuned by adjusting the temperature and pressure. Because of the barrier set by the supercritical water cage, hydrocarbon radical transfer is more difficult in supercritical water as compared to conventional thermal cracking processes, such as delayed coker, where radicals travel freely without such barriers.

The following embodiments, provided with reference to the figures, describe the process to produce in situ catalyst particles and upgrade a heavy oil.

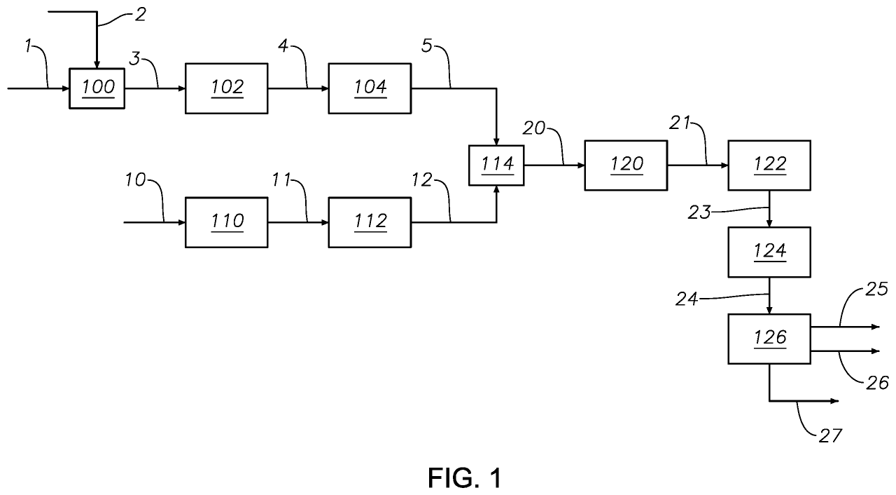

Referring to FIG. 1 an embodiment of the system and process for upgrading heavy oil with in situ produced catalyst particles is provided.

Feed water 1 is introduced to catalyst mixer 100 along with catalyst precursor solution 2. Feed water 1 contains water. Feed water 1 can be any source of water having a conductivity less than 1 microsiemens (μS)/centimeter (cm), alternately less than 0.5 μS/cm, and alternately less than 0.1 μS/cm. Examples of sources of feed water 1 include demineralized water, distilled water, boiler feed water (BFW), deionized water, and combinations of the same.

Catalyst precursor solution 2 contains a catalyst precursor dissolved in liquid water. The catalyst precursor can be any ionic compound containing a cation and an anion. Examples of cations suitable for use include transition metals from periods 4 to 6, groups 4 to 12 of the periodic table, cerium, and combinations of the same. In at least one embodiment, the cations include transition metals from period 4, groups 4 to 12, alone or in combination. In at least one embodiment, the cations include chromium, iron, cobalt, nickel, copper, zinc, molybdenum, and combinations of the same. Examples of anions include nitrates, sulfates, chlorides, acetates, acetyl acetonate (acac), formates and combinations of the same. In at least one embodiment, the anionic compounds include nitrate, acetate, acetyl acetonate, and combinations of the same. In at least one embodiment, the catalyst precursor includes a molybdate anion and an ammonium-containing cation as a precursor to forming molybdenum compounds. Molybdenum compounds can include molybdenum trioxide. The cation concentration, including metallic cations, in the catalyst precursor solution can be in the range of 0.07 mM to 7.3M. The anion concentration, including metallic anions, can be in the range of 0.07 mM to 7.3M. Catalyst precursor solution 2 is in the absence of liquid acids, liquid alkalis, alcohols, hydrogen peroxides, or combinations of the same. Examples of liquid acids include acrylic acid.

Both feed water 1 and catalyst precursor solution 2 can be at ambient conditions and alternately at a pressure between ambient pressure and 0.1 MPa. Alternately, feed water 1 can be at a temperature between ambient temperature and 100° C. The operating conditions of feed water 1 and catalyst precursor solution 2 depend on the source from which the feed water 1 and catalyst precursor solution 2 were pulled, such as storage tanks. The operating temperature of catalyst precursor solution 2 can be heated to aid in dissolving the catalyst precursor in the liquid water, however the temperature is maintained at less than 100° C. The temperature of catalyst precursor solution 2 is maintained at less than 100° C. to keep the water in the liquid state.

The ratio of the mass flow of feed water 1 to catalyst precursor solution 2 is in the range of 1:0.05 to 1:1, alternately in the range of 1:0.1 to 1:1. In at least one embodiment, the ratio of the mass flow of feed water 1 to catalyst precursor solution 2 is 1:0.1.

Feed water 1 and catalyst precursor solution 2 are mixed in catalyst mixer 100 to produce metal-containing water 3. Catalyst mixer 100 can be any type of mixing unit capable of mixing two streams. Examples of catalyst mixer 100 includes inline mixer, T-fitting, Y-fitting, and combinations of the same.

Metal-containing water 3 can be pressurized in water pump 102 to produce pressurized water stream 4. Water pump 102 can be any type of pump capable of increasing a pressure of a water stream. The pressure of pressurized water stream 4 can be in the range between 22 MPa and 35 MPa and alternately in the range between 23 MPa and 28 MPa. Pressurized water stream 4 can be introduced to water preheater 104.

The temperature of pressurized water stream 4 can be increased in water preheater 104 to produce supercritical water stream 5. Catalyst precursor in pressurized water stream 4 can be converted to catalyst particles in water preheater 104.

Supercritical water serves as an excellent solvent for producing sub-micron sized metal oxide particles in a short amount of time, on the order of minutes. When a solute's concentration increases beyond the solubility concentration (Cs), supersaturation state is achieved. Further increases of the solute concentration over critical nucleation concentration (Cₘᵢₙ) initiates nuclei formation. Due to consumption of solute into nuclei, the solute concentration decreases below Cₘᵢₙ and growth of particles starts by adsorption of solute into the nuclei, Ostwald ripening (redissolution of small nuclei and depositing into the larger nuclei), and coalescence of small nuclei into large particles. In order to produce fine particles having narrow size distribution, the nucleation rate must be significantly faster than the growth rate. In other words, growth of particles must be suppressed while nucleation is accelerated. In conventional hydrothermal methods, it can take a long time to increase solute concentration, which is typically done by heating. This means that under conventional methods, solute concentration may stay below the critical nucleation concentration (Cₘᵢₙ) for significant periods and the growth stage dominates the particle production process.

Supercritical water serves an excellent solvent because it can induce “explosive” nucleation due to its low dielectric constant where ionic compounds have very low solubility. Under normal conditions, metals salts completely dissolve in liquid water. At supercritical conditions, metal salts are precipitated due to low dielectric constant of supercritical water. The abrupt change of solubility induces sudden nucleation in a very short amount of time.

The small particle size and narrow size distribution of catalyst particles produced in supercritical water is further enabled because any metal hydroxide, the product of the hydrolysis of metal salts, produced is consumed in the production of metal oxides.

By the above described process, the catalyst precursor in the catalyst precursor solution is converted to catalyst particles. The catalyst particles are metal oxides. The catalyst particles are in the absence of metal sulfides, organometallic compounds, organically modified metal oxide, and combinations of the same. Converting catalyst precursor to catalyst particles is in the absence of added hydrogen and hydrogen sulfide.

Water preheater 104 can be any type of vessel, pipe, or tubular capable of increasing a temperature of an internal fluid and maintaining a Reynolds number of the internal fluid of greater than 6,000, alternately greater than 10,000, alternately between 6,000 and 100,000, and alternately between 10,000 and 100,000. The upper limit of Reynolds number can be determined by pressure drop through water preheater 104. Maintaining a Reynolds number greater than 6,000 ensures dispersion of the catalyst precursor and catalyst particles in the supercritical water. Examples of water preheater 104 can include electric heater, heat exchanger, and combinations of the same. The residence time of the internal fluid in water preheater 104 can be between 0.05 minutes and 10 minutes, and alternately between 0.1 minutes and 5 minutes. In at least one embodiment, the residence time of the internal fluid in water preheater 104 is between 0.1 minutes and 5 minutes. The temperature of supercritical water stream 5 can be in the range between 374° C. and 500° C., and alternately between 400° C. and 450° C. Maintaining a temperature in water preheater 104 between 374° C. and 500° C. avoids complete conversion of the metal catalyst precursors to catalyst oxide particles. Supercritical water stream 5 contains the precursor catalyst and water at supercritical conditions. Supercritical water stream 5 can be introduced to mixer 114.

The residence time of fluid in the process line from the exit of water preheater to inlet of the reactor is less than 0.1 minutes. This includes the residence time of the fluid through mixer 114.

Feed oil 10 can be introduced to oil pump 110. Feed oil 10 can be any type of heavy oil stream. Examples of oil streams suitable for use as feed oil 10 include whole range crude oil, distilled crude oil, reduced crude oil, topped crude oil, residue oil, product streams from oil refineries, product streams from steam cracking processes, liquefied coals, liquids recovered from oil or tar sands, bitumen, shale oil, asphaltene, biomass hydrocarbons, liquids recovered from plastic pyrolysis, and combinations of the same. Feed oil 10 can be at a temperature between ambient and 200° C. The temperature of feed oil 10 can be elevated above ambient to reduce the viscosity to make feed oil 10 pumpable.

The pressure of feed oil 10 can be increased in oil pump 110 to produce pressurized oil stream 11. Oil pump 110 can be any type of pump capable of pumping a heavy oil stream. The pressure of pressurized oil stream 11 can be between 22 MPa and 35 MPa, and alternately between 23 MPa and 28 MPa. Pressurized oil stream 11 can be introduced to oil preheater 112.

The temperature of pressurized oil stream 11 can be increased in oil preheater 112 to produce hot oil stream 12. Oil preheater 112 can be any type of heat exchanger capable of increasing a temperature of a heavy oil stream. The temperature of hot oil stream 12 can be in the range between 100° C. and 250° C. Hot oil stream 12 can be introduced to mixer 114.

The mass flow ratio of supercritical water stream 5 to hot oil stream 12 can be in the range of 0.1:1 and 10:1, and alternately in the range of 2:1 and 10:1. In at least one embodiment, the mass flow ratio of supercritical water stream 5 to hot oil stream 12 is 2:1. The mass flow ratio of supercritical water stream 5 to feed water 1 can be in the range of 1.05:1 to 2:1, and alternately in the range of 1.1:1 and 2:1. The mass flow ratio of hot oil stream 12 to catalyst precursor solution 2 can be in the range of 1:0.005 to 1:5, and alternately in the range of 1:0.182 to 1:5. In at least one embodiment, the mass flow ratio of hot oil stream 12 to catalyst precursor solution 2 is in the range of 1:0.182.

The mass ratio of metal oxide to hot oil stream 12 is in the range of 0.00005:1 and 0.005:1, and alternately in the range of 0.0005:1 to 0.005:1. The weight percent of metal oxide relative to the weight of hot oil stream 12 is in the range from 0.005 wt % (50 ppm wt) to 0.498 wt % (4975 ppm wt). In at least one embodiment weight percent of metal oxide relative to the weight of hot oil stream 12 is 0.050 wt % (500 ppm wt). Table 1 contains examples of how the mass ratio of metal oxide to hot oil stream 12 translates to molar concentration of the cationic compounds titanium and molybdenum as the catalyst precursor. The atomic mass of titanium is 47.84 and the formula weight of titanium dioxide is 79.82 g/mol. The atomic mass of molybdenum is 96 and the formula weight for molybdenum trioxide is 143.97 g/mol.

TABLE 1

| | | Total weight | Wt ratio of | |
|---|---|---|---|---|
| | Wt ratio | of catalyst | metal oxide | |
| | metal oxide | precursor | to catalyst | Molar concentration |
| | to hot oil | solution 2 | precursor | of cation in catalyst |
| | stream 12 | (kg) | solution 2 | precursor solution 2 |
| Ti | 0.00005 to 1 | 0.004762 | 0.00001 to 1 | 0.0001 |
| Ti | 0.0005 to 1 | 0.181818 | 0.00275 to 1 | 0.0345 |
| Ti | 0.005 to 1 | 5 | 1.05 to 1 | 13.1546 |
| Mo | 0.00005 to 1 | 0.004762 | 0.00001 to 1 | 0.00007 |
| Mo | 0.0005 to 1 | 0.181818 | 0.00275 to 1 | 0.01910 |
| Mo | 0.005 to 1 | 5 | 1.05 to 1 | 7.29319 |

Supercritical water stream 5 and hot oil stream 12 can be mixed in mixer 114 to produce mixed stream 20. Mixer 114 can be any type of mixer capable of mixing a hot oil stream and a supercritical water stream. Examples of mixer 114 include t-fitting mixer, y-fitting mixer, a line mixer, and combinations of the same. The temperature of mixed stream 20 is at a temperature between 320° C. and 370° C.

Mixing the hot oil stream 20 and supercritical water stream 5 brings the hydrocarbons in contact with the supercritical water. Not all hydrocarbon fractions in hot oil stream 5 can be dissolved in the supercritical water of supercritical water stream 5. In particular, the asphaltenic fraction is not fully soluble in supercritical water. The catalyst particles are denser than the phase of hydrocarbons dissolved in the supercritical water. Thus, as the two streams mix, the catalyst particles will mix with the fractions that do not dissolve in supercritical water, namely the asphaltenic fraction. Advantageously, the dissolved hydrocarbons of hot oil stream 20 do not require catalyst to be upgraded and do not bond to or modify the surface of the catalyst particles. Hydrocarbons dissolved in supercritical water can be upgraded without the help of catalyst. Mixed stream 20 can be introduced to reactor 120.

Reactor 120 can be any type of reactor capable of maintaining catalytic reactions. In at least one embodiment, reactor 120 is a slurry-bed reactor. In reactor 120, the catalyst particles catalyze upgrading reactions, including demetallization reactions, denitrogenation reactions, and desulfurization reactions of the hydrocarbons from feed oil 10. The production of coke is reduced or eliminated in reactor 120.

Reactor 120 can be any type of vessel capable of acting as a slurry-bed reactor. Examples of vessels suitable for use as a slurry-bed reactor include a tubular reactor, vessel reactor, a continuous stirred tank reactor (CSTR), and combinations of the same. In at least one embodiment, reactor 120 is a tubular reactor where fluid flows downward. Reactor 120 is in the absence of externally provided hydrogen. Reactor 120 is in the absence of externally provided hydrogen sulfide. Reactor 120 can be designed to have Reynolds greater than 6,000, and alternately 10,000. The residence time of reactor 120 is in the range of 0.1 and 60 minutes, and alternately in the range of 1 minutes and 10 minutes. The temperature in reactor 120 can be between 380° C. and 500° C., and alternately between 380° C. and 450° C. The pressure in reactor 120 can be between 22 MPa and 35 MPa, and alternately between 23 MPa and 28 MPa. In at least one embodiment, reactor 120 is at a temperature between 380° C. 450° C. and at a pressure between 23 MPa and 28 MPa. Catalytic reactions of heavy oil occur in reactor 120 to produce reactor effluent 21.

The process lines, such as the piping, valves, and fittings, connecting water preheater 104, mixer 114, and reactor 120 can be designed to have a Reynolds number greater than 6,000 and alternately greater than 10,000. In at least one embodiment, the Reynolds number is greater than 10,000.

Reactor effluent 21 can be introduced to cooling unit 122. Cooling unit 122 can be any type of unit that can reduce the temperature of a reactor effluent. Examples of cooling unit 122 include a heat exchanger, an air cooler, and combinations of the same. Examples of heat exchanger include a shell-and-tube type exchanger, a double-pipe type exchanger, and combinations of the same. In embodiments where cooling unit 122 is a shell and tube type heat exchanger, reactor effluent 21 is introduced through the tube side to reduce or prevent the sedimentation of catalysts, which would occur on the shell side of the heat exchanger. Cooling unit 122 is designed to have a Reynolds number greater than 6,000 and alternately greater than 10,000. The temperature of reactor effluent 21 can be reduced in cooling unit 122 to produce cooled effluent 23. The temperature of cooled effluent can be less than 374° C., alternately between 150° C. and 374° C., and alternately between 150° C. and 350° C.

The process lines, such as the piping, valves, and fittings, connecting reactor 120 and cooling unit 122 can be designed to have a Reynolds number greater than 6,000 and alternately greater than 10,000.

Cooled effluent 23 is introduced to pressure let-down device 124. Pressure let-down device 124 can be any type of unit capable of reducing the pressure of a stream containing solid particles. Examples of pressure let-down device 124 include a dome-type back pressure regulator, multistage pressure regulator, a pressure control valve, and combinations of the same. In at least one embodiment, pressure let-down device 124 is a multi-stage pressure regulator where the pressure is reduced in multiple stages. The pressure of cooled effluent 23 is reduced in pressure let-down device 124 to produce depressurized effluent 24. The pressure of depressurized effluent 24 is between ambient pressure and 0.5 MPa.

Depressurized effluent 24 can be introduced to separator unit 126. Separator unit 126 can be any type of unit capable of separating a vapor stream, a water stream, and an oil stream. Separator unit 126 can include a separator capable of separating multiple phases simultaneously or can be a combination of two or more separators. Examples of separator unit 126 include a distillation column, a flash column, a gas-liquid separator, a liquid-liquid separator, and combinations of the same. In at least one embodiment, separator unit 126 can be a flash column, a gas-liquid separator, a liquid-liquid separator, and combination of the same. In embodiments where separator unit 126 includes a liquid-liquid separator, a demulsifier can be added to separator unit 126 to enhance the separation of oil and water. Depressurized effluent 24 is separated in separator unit 126 to produce product gas 25, product oil 26, and product water 27.

Product water 27 can be subjected to a water treatment unit to produce a treated water stream. The water treatment unit can be any type of treatment system for removing impurities from a water stream. In at least one embodiment, the water treatment unit is a membrane-based process deploying multiple membrane units. Examples of impurities that can be removed in the water treatment unit include solids, organic compounds, and inorganic compounds. The treated water can be reused in the process or disposed of.

Product oil 26 can be introduced to a distillation column to separate the fractions in product oil 26. The catalyst particles accumulate in the bottom fraction of product oil 26. Catalyst particles can be surrounded by hydrocarbons, which are adsorbed on the catalyst particles, making the catalyst particles hydrophobic. Product oil 26 is separated in the distillation column to produce the bottom fraction and an upgraded oil product. The bottom fraction can be introduced to a bottoms separation unit. Bottoms separation unit can be any separation unit capable of separating solids from a liquid. Examples of separation units include solvent extraction units, filter units, centrifuge units, and combinations of the same. The catalyst particles are separated in bottoms separation unit to produce separated catalyst and bottoms fraction stream.

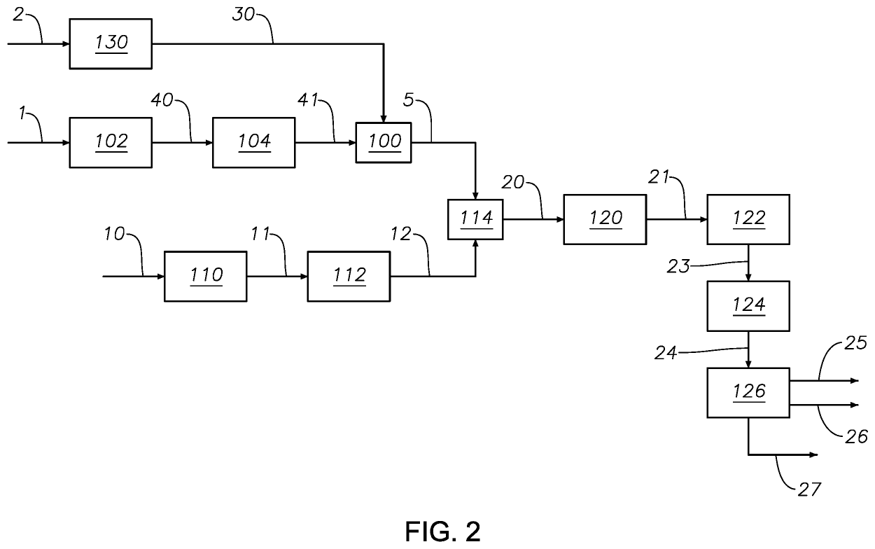

Referring to FIG. 2, an alternate embodiment of the production of in situ catalyst for upgrading heavy oil is provided with reference to FIG. 1.

The pressure of feed water 1 is increased in water pump 102 to produce pressurized feed water 40. The temperature of pressurized feed water 40 is increased in water preheater 104 to produce supercritical feed water 41. Water pump 102 and water preheater 104 are described with reference to FIG. 1. Supercritical feed water 41 is at supercritical conditions, such that the water in supercritical feed water 41 is supercritical water. The temperature of supercritical feed water 41 can be between 400° C. and 600° C. The temperature of supercritical feed water 41 is adjusted such that supercritical water stream 5 is at a temperature between 374° C. and 500° C., and alternately between 400° C. and 450° C. The temperature of supercritical feed water 41 and supercritical water stream 5 can be adjusted based on feedback from instruments that measure temperature. Supercritical feed water 41 is introduced to catalyst mixer 100.

The pressure of catalyst precursor solution 2 is increased in precursor pump 130 to produce pressurized precursor solution 30. Precursor pump 130 can be any type of pump capable of increasing the pressure of a fluid. The pressure of pressurized precursor solution 30 can be in the range from 22 MPa to 35 MPa. Pressurized precursor solution 30 is introduced to catalyst mixer 100 to produce supercritical water stream 5.

In embodiments described with reference to FIG. 2, the catalyst particles are formed in the process line between catalyst mixer 100 and mixer 114 through which supercritical water stream 5 flows. The process line can be designed to have a Reynolds number greater than 6,000 and alternately greater than 10,000. The residence time of the internal fluid in the process line through which supercritical water stream 5 flows can be in the range of 0.05 minutes to 10 minutes, and alternately between 0.1 minutes and 5 minutes. The embodiment described with reference to FIG. 2, ensures the catalysts are generated before contacting the feed oil from feed oil 10. In the embodiment described with reference to FIG. 2, catalyst particles are not present in supercritical water feed 41, but are only produced in after pressurized precursor solution 30 is mixed with supercritical feed water 41 to produce supercritical water stream 5.

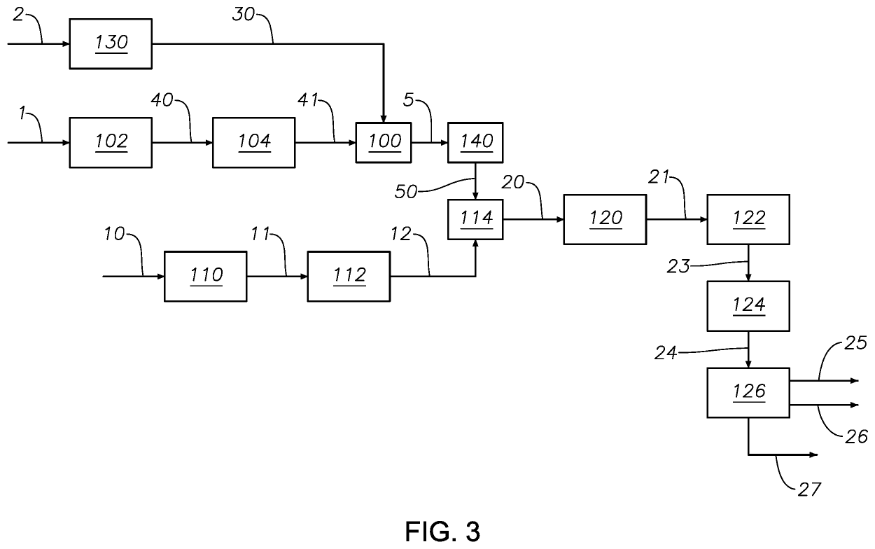

Referring to FIG. 3, an alternate embodiment of the production of in situ catalyst particles for upgrading heavy oil is provided with reference to FIG. 1 and FIG. 2.

The temperature of supercritical feed water 41 is adjusted such that supercritical water stream 5 has a temperature between 300° C. and 370° C., and alternately between 350° C. and 370° C. The near critical conditions, where pressure is greater than the critical pressure of water and temperature is less than the critical temperature of water, enhances hydrolysis because of low pKw, high concentration of OH—, of water in the near critical region. The process line connecting catalyst mixer 100 and catalyst heater 140 is designed to maintain a Reynolds of the flow of supercritical water stream 5 greater than 6,000 and alternately greater than 10,000. The residence time in the process line between catalyst mixer 100 and catalyst heater 140 is between 0.01 minutes and 10 minutes, and alternately between 0.1 minutes and 2 minutes. Supercritical water stream 5 is introduced to catalyst heater 140.

Catalyst heater 140 can be any type of unit capable of increasing a temperature of an internal fluid stream. Examples of units suitable for use as catalyst heater 140 include electric heater, heat exchanger, and combinations of the same. The temperature of supercritical water stream 5 is increased in catalyst heater 140 to produce catalyst-containing water 50. The temperature of catalyst-containing water 50 can be in the range between 374° C. and 500° C., and alternately 400° C. and 450° C. Catalyst precursor in supercritical water stream 5 can be converted to catalyst particles in catalyst heater 140.

Catalyst-containing water 50 is introduced to mixer 114.

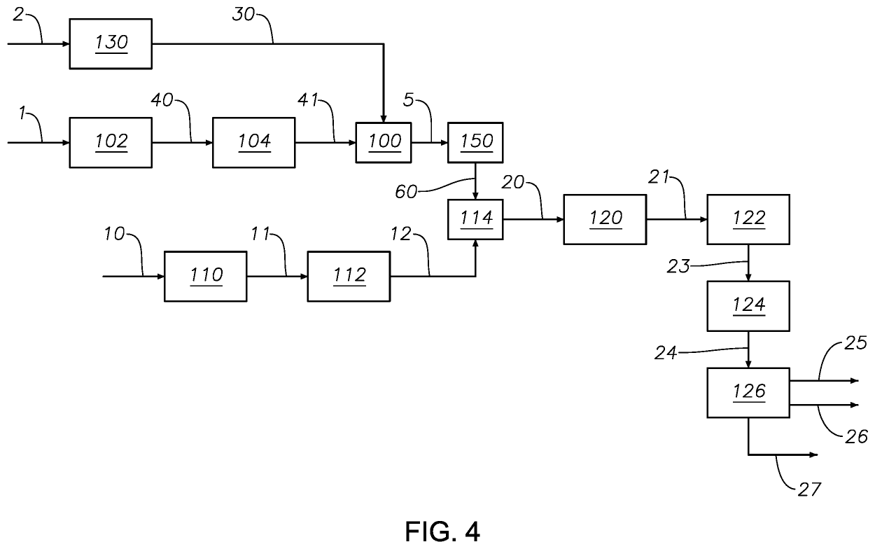

Referring to FIG. 4, an alternate embodiment of the production of in situ catalyst for upgrading heavy oil is provided with reference to FIG. 1 and FIG. 2.

The pressure of both pressurized precursor solution 30 and pressurized feed water 40 is adjusted to be at least 0.1 MPa greater than the pressure of pressurized oil stream 11, and alternately greater than 0.2 MPa greater than the pressurized oil stream 11. As a result, the pressure of pressurized precursor solution 30, pressurized feed water 40, supercritical feed water 41, and supercritical water stream 5 are greater than the pressure of hot oil stream 12, mixed stream 20, and pressure regulated catalyst stream 60. Supercritical water stream 5 is introduced to catalyst pressure control 150.

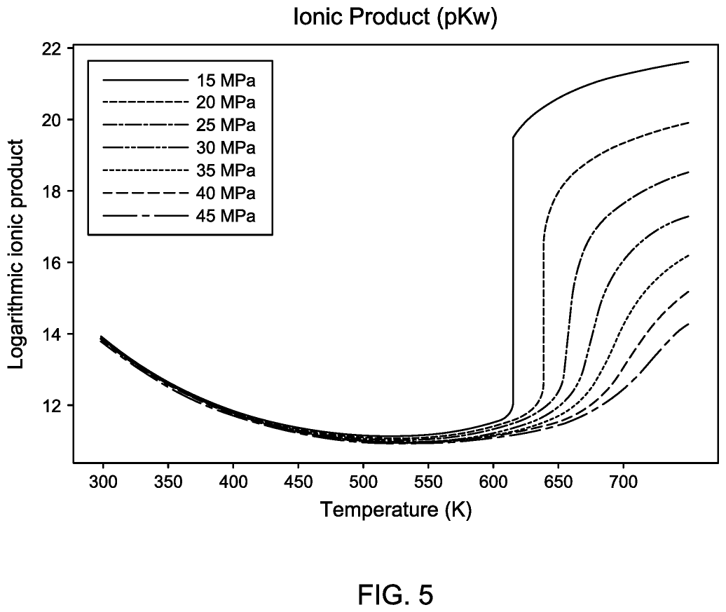

Catalyst pressure control 150 can be any type of pressure device that can control the pressure of a fluid stream. Examples of catalyst pressure control 150 include pressure control valve and back pressure regulator. Catalyst pressure control 150 operates to maintain a pressure in supercritical water stream 5 that is greater than the pressure in pressure regulated catalyst stream 60. As shown in FIG. 5, there is a relationship between pressure and pKw, with increased pressure resulting in reduced pKw, which means more hydroxide (OH⁻) in the supercritical water.

Operating the step of converting the catalyst precursor to catalyst particles at an increased pressure relative to upgrading the heavy oil in reactor 120 is advantageous because the operating conditions in reactor 120 can be optimized. Reducing the pressure through catalyst pressure control 150 reduces the ionic property of supercritical water resulting in improved behavior of the supercritical water as a solvent for upgrading the hydrocarbons from oil feed 10.

Catalyst precursor is converted to catalyst particles in the process line connecting catalyst mixer 100 to catalyst pressure control 150 and in the process line connecting catalyst pressure control 150 to mixer 114. Both supercritical water stream 5 and pressure regulated catalyst stream 60 contain catalyst precursor, catalyst particles, and water at supercritical conditions. The residence time of the internal fluid from the outlet of catalyst mixer 100 to the inlet of mixer 114 is between 0.05 minutes and 10 minutes, and alternately between 0.1 minutes and 5 minutes. In at least one embodiment, the residence time of supercritical water stream 5 in the process line connecting catalyst mixer 100 and catalyst pressure control 150 is between 0.05 minutes and 5 minutes and the residence time of pressure regulated catalyst stream 60 in the process line connecting catalyst pressure control 150 and mixer 114 is between 0.1 minutes and 7 minutes.

The system and process for upgrading heavy oil with in situ produced catalyst particles is in the absence of externally added catalyst, including ex situ produced catalyst. The catalyst particles present in reactor were produced in situ. The catalyst precursor in the catalyst precursor solution does not possess catalytic properties. The catalyst particles are formed in the operating units or piping connecting the units and are not separated or recovered from the aqueous stream before entering the reactor. The catalyst particles are not formed directly from compounds or complexes present in the feed oil. The system and process for upgrading heavy oil with in situ produced catalyst particles is in the absence of incorporating the catalyst precursor or catalyst particles directly into the feed oil. In the system and process for upgrading heavy oil with in situ produced catalyst particles described here, the catalyst particles are not produced in a stream containing feed oil and are produced before the water containing catalyst precursor and catalyst particles are mixed with the feed oil. The number of catalyst precursors that can completely dissolve in feed oil is limited and conversion of catalyst precursors to catalyst particles requires water at supercritical conditions. Thus, incorporating the catalyst precursor in the feed oil would not produce catalyst particles before being injected into the reactor. The system and process for upgrading heavy oil with in situ produced catalyst particles is in the absence of added organic modifiers separate from the feed oil.

### EXAMPLES

Example 1 was modeled on FIG. 2. Feed oil 10 was an atmospheric residue from crude oil having the properties shown in Table 2.

TABLE 2
Properties of Feed Oil

| Property | Unit | Value |
|---|---|---|
| Specific Gravity | API Gravity | 10.7 |
| Total Sulfur | wt % sulfur | 4.74 |
| Conradson Carbon Residue | Wt % | 16.3 |
| Nitrogen | Wt ppm | 2740 |
| Vanadium | Wt ppm | 237 |
| Nickel | Wt ppm | 32 |
| Distillation(ASTM D7169) | | |
| 5% | Degree C. | 383 |
| 10% | Degree C. | 406 |
| 20% | Degree C. | 442 |
| 30% | Degree C. | 480 |
| 50% | Degree C. | 534 |
| 70% | Degree C. | 601 |
| 80% | Degree C. | 632 |
| 90% | Degree C. | 678 |
| 95% | Degree C. | 710 |

The catalyst precursor was ammonium heptamolybdate tetrahydrate((NH₄)₆Mo₇O₂₄4H₂O). Catalyst precursor solution 2 was prepared by dissolving the ammonium heptamolybdate tetrahydrate in water resulting in catalyst precursor solution 2 having 0.0176 Mole of molybdenum ion/Liter of aqueous solution. The flow rates and operating conditions of the streams are shown in Table 3. The amount of catalyst precursor was 0.414 kg MoO₃/1 metric tonnes (MT) of feed oil. The catalyst content was about 400 wt ppm of feed oil 10.

Reactor 120 was a tubular reactor. The residence time in reactor 120 was estimated to be about 2.9 minutes. The residence time of supercritical water stream 5 was 0.2 minutes.

TABLE 3
Process Operating Conditions

| | | Mass | | |
|---|---|---|---|---|
| | | Flow | | |
| | | (MT/ | Temperature | Pressure |
| Stream | | hour) | (° C.) | (MPa) |
| 1 | Feed Water | 33 | 25 | 0.01 |
| 40 | Pressurized Feed Water | 33 | — | 27.5 |
| 41 | Supercritical Feed Water | 33 | 480 | 27.5 |
| 2 | Catalyst Precursor Solution | 2.8 | 25 | 0.01 |
| 30 | Pressurized Precursor Solution | 2.8 | — | 27.5 |
| 5 | Supercritical Water Stream | 35.8 | 430 | 27.5 |
| 10 | Feed Oil | 17.1 | 110 | 0.2 |
| 11 | Pressurized Oil Stream | 17.1 | — | 27.5 |
| 12 | Hot Oil Stream | 17.1 | 180 | 27.5 |
| 20 | Mixed Stream | 52.9 | 391 | 27.5 |
| 21 | Reactor Effluent | 52.9 | 450 | 27.3 |
| 23 | Cooled Effluent | 52.9 | 250 | 27.2 |
| 24 | Depressurized Effluent | 52.9 | 140 | 0.34 |

Product oil 26 had a 97.1 wt % recovery, which means that 2.9 wt % of feed oil 10 was lost to product gas 25 and product water 27, as dissolved organics. The properties of product oil 26 are shown in Table 4.

TABLE 4
Properties of Product Oil 26

| Property | Unit | Value |
|---|---|---|
| Specific Gravity | API Gravity | 16.6 |
| Total Sulfur | wt % sulfur | 1.47 |
| Conradson Carbon Residue | Wt % | 11.60 |
| Nitrogen | Wt ppm | 810 |
| Vanadium | Wt ppm | 55 |
| Nickel | Wt ppm | 11 |
| Distillation (ASTM D7169) | | |
| 5% | Degree C. | 108 |
| 10% | Degree C. | 240 |
| 20% | Degree C. | 338 |
| 30% | Degree C. | 384 |
| 50% | Degree C. | 454 |
| 70% | Degree C. | 526 |
| 80% | Degree C. | 564 |
| 90% | Degree C. | 614 |
| 95% | Degree C. | 649 |

Example 2.

Example 2 was a comparative example. The operating conditions, properties of feed oil and equipment used were the same. In Example 2 no precursor catalyst solution was used. Feed water 1 was distilled water. The mixed stream to the reactor contained only supercritical water and feed oil and was in the absence of catalyst precursor or catalyst particles. The properties of the resulting product oil are shown in Table 5.

TABLE 5
Properties of Product Oil in Example 2

| Property | Unit | Value |
|---|---|---|
| Specific Gravity | API Gravity | 13.7 |
| Total Sulfur | wt % sulfur | 4.10 |
| Conradson Carbon Residue | Wt % | 12.80 |
| Nitrogen | Wt ppm | 1520 |
| Vanadium | Wt ppm | 210 |
| Nickel | Wt ppm | 28 |
| Distillation (ASTM D7169) | | |
| 5% | Degree C. | 304 |
| 10% | Degree C. | 343 |
| 20% | Degree C. | 391 |
| 30% | Degree C. | 425 |
| 50% | Degree C. | 491 |
| 70% | Degree C. | 559 |
| 80% | Degree C. | 599 |
| 90% | Degree C. | 649 |
| 95% | Degree C. | 681 |

Comparing the results of Table 4 and Table 5 shows that the presence of catalyst in the reactor results in increased upgrading reactions, including increased desulfurization, demetallization, and denitrogenation of the product oil.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

There various elements described can be used in combination with all other elements described here unless otherwise indicated.

The singular forms “a”, “an” and “the” include plural referents, unless the context clearly dictates otherwise.

Optional or optionally means that the subsequently described event or circumstances may or may not occur. The description includes instances where the event or circumstance occurs and instances where it does not occur.

Ranges may be expressed here as from about one particular value to about another particular value and are inclusive unless otherwise indicated. When such a range is expressed, it is to be understood that another embodiment is from the one particular value to the other particular value, along with all combinations within said range.

Throughout this application, where patents or publications are referenced, the disclosures of these references in their entireties are intended to be incorporated by reference into this application, in order to more fully describe the state of the art to which the invention pertains, except when these references contradict the statements made here.

As used here and in the appended claims, the words “comprise,” “has,” and “include” and all grammatical variations thereof are each intended to have an open, non-limiting meaning that does not exclude additional elements or steps.

1. A process for treating a feed oil in the presence of in situ produced catalyst particles, the process comprising the steps of:
increasing a pressure of a catalyst precursor solution in a precursor pump to produce a pressurized precursor solution;
increasing a pressure of a feed water in a water pump to produce a pressurized feed water;
increasing a temperature of the pressurized feed water in a water preheater to produce a supercritical water feed;
mixing the supercritical water feed with the pressurized precursor solution in a catalyst mixer to produce a supercritical water stream, where the supercritical water stream is at a temperature between 374° C. and 500° C. and a pressure between 22 MPa and 35 MPa;
withdrawing the supercritical water stream to a process line connecting the catalyst mixer to a mixer, where the catalyst precursor is converted to catalyst particles in the process line in the absence of added hydrogen and hydrogen sulfide such that the supercritical water stream comprises water at supercritical conditions and the catalyst particles, where the catalyst particles comprise metal oxides, where the Reynolds number of the supercritical water stream in the process line is greater than 6,000, where the residence time in the process line is between 0.05 minutes and 10 minutes;
increasing a pressure of the feed oil in an oil pump to produce a pressurized oil stream, where the feed oil comprises heavy oil;
increasing a temperature of the pressurized oil stream to produce a hot oil stream;
mixing the supercritical water stream and the hot oil stream in the mixer to produce a mixed stream, where the mass flow ratio of the supercritical water stream to the hot oil stream is in the range of 0.1:1 and 10:1, where the mass ratio of metal oxide to the hot oil stream is in the range of 0.00005:1 and 0.005:1;
introducing the mixed stream to a reactor, where the reactor is operated at a temperature between 380° C. and 500° C. and a pressure between 22 MPa and 35 MPa;
processing the heavy oil in the reactor in the presence of the catalyst particles to produce a reactor effluent, where the catalyst particles catalyze upgrading reactions of the heavy oil;
reducing a temperature of the reactor effluent in a cooling unit to produce a cooled effluent;
reducing a pressure of the cooled effluent in a pressure let-down device to produce a depressurized effluent; and
separating the depressurized effluent in a separator unit to produce a product gas, a product oil, and a product water.

2. The process of claim 1, where the precursor catalyst comprises a cation and an anion.

3. The process of claim 2, wherein the cation is selected from the group consisting of transition metals from periods 4 to 6, groups 4 to 12 of the periodic table, cerium, and combinations of the same.

4. The process of claim 2, wherein the anion is selected from the group consisting of sulfates, chlorides, acetates, acetyl acetonate, formates and combinations of the same.

5. The process of claim 1, further comprising the steps of:
introducing the product oil to a distillation column;
separating the product oil in the distillation column to produce a bottom fraction and an upgraded oil product, where the bottom fraction comprises catalyst particles;
introducing the bottom fraction to a bottoms separation unit; and
separating the catalyst particles in the bottoms separation unit to produce separated catalyst and a bottoms fraction stream.

6. A system for treating a heavy oil in the presence of in situ produced catalyst particles, the system comprising:
a precursor pump, the precursor pump configured to increase a pressure of a catalyst precursor solution to produce a pressurized precursor solution;
a water pump, the water pump configured to increase a pressure of a water feed to produce a pressurized feed water;
a water preheater fluidly connected to the water pump, the water preheater configured to increase a temperature of the pressurized feed water to produce a supercritical water feed;
a catalyst mixer fluidly connected to the precursor pump and the water preheater, the catalyst mixer configured to mix the supercritical water feed with the pressurized precursor solution in to produce a supercritical water stream, where the supercritical water stream is at a temperature between 374° C. and 500° C. and a pressure between 22 MPa and 35 MPa;
a process line connecting the catalyst mixer to a mixer, where the catalyst precursor is converted to catalyst particles in the process line such that the supercritical water stream comprises water at supercritical conditions and the catalyst particles, where the catalyst particles comprise metal oxides, where the Reynolds number of the supercritical water stream in the process line is greater than 6,000, where the residence time in the process line is between 0.05 minutes and 10 minutes;
the mixer configured to the supercritical water stream and a hot oil stream in the mixer to produce a mixed stream, where the mass flow ratio of the supercritical water stream to the hot oil stream is in the range of 0.1:1 and 10:1, where the mass ratio of metal oxide to the hot oil stream is in the range of 0.00005:1 and 0.005:1, where the hot oil stream comprises the heavy oil;
a reactor fluidly connected to the mixer, the reactor configured to maintain upgrading reactions of the heavy oil to produce a reactor effluent, where the reactor is operated at a temperature between 380° C. and 500° C. and a pressure between 22 MPa and 35 MPa, where the catalyst particles catalyze the upgrading reactions of the heavy oil;
a cooling unit fluidly connected to the reactor, the cooling unit configured to reduce a temperature of the reactor effluent to produce a cooled effluent;
a pressure let-down device fluidly connected to the cooling unit, the pressure let-down device configured to reduce a pressure of the cooled effluent to produce a depressurized effluent; and
a separator unit fluidly connected to the pressure let-down device, the separator unit configured to separate the depressurized effluent to produce a product gas, a product oil, and a product water.

7. The system of claim 6, where the precursor catalyst comprises a cation and an anion.

8. The system of claim 7, wherein the cation is selected from the group consisting of transition metals from periods 4 to 6, groups 4 to 12 of the periodic table, cerium, and combinations of the same.

9. The system of claim 7, wherein the anion is selected from the group consisting of sulfates, chlorides, acetates, acetyl acetonate, formates and combinations of the same.

10. The system of claim 6, further comprising:
a distillation column fluidly connected to the separator unit, the distillation column configured to separate the product oil to produce a bottom fraction and an upgraded oil product, where the bottom fraction comprises catalyst particles; and
a bottoms separation unit fluidly connected to the distillation column, the bottoms separation unit configured to separate the catalyst particles to produce separated catalyst and a bottoms fraction stream.

11. The system of claim 6, further comprising:
an oil pump, the oil pump configured to increase a pressure of a feed oil to produce a pressurized oil stream, where the feed oil comprises the heavy oil; and
an oil preheater fluidly connected to the oil pump, the oil preheater configured to increase a temperature of the pressurized oil stream to produce the hot oil stream, where the hot oil stream is at a temperature in the range between 100° C. and 250° C. and a pressure between 22 MPa and 35 MPa.

12. A process for treating a feed oil in the presence of in situ produced catalyst particles, the process comprising the steps of:
mixing a feed water with a catalyst precursor solution in a catalyst mixer to produce a metal-containing water stream, where the catalyst precursor solution comprises a catalyst precursor dissolved in liquid water;
increasing a pressure of the metal-containing water stream in a water pump to produce a pressurized water stream;
increasing a temperature of the pressurized water stream in a water preheater to produce a supercritical water stream, where the supercritical water stream is at a temperature between 374° C. and 500° C. and a pressure between 22 MPa and 35 MPa, where the catalyst precursor is converted to catalyst particles in the water preheater in the absence of added hydrogen and hydrogen sulfide such that the supercritical water stream comprises water at supercritical conditions and the catalyst particles, where the catalyst particles comprise metal oxides, where the Reynolds number of the pressurized water stream is greater than 6,000;
increasing a pressure of the feed oil in an oil pump to produce a pressurized oil stream, where the feed oil comprises heavy oil;
increasing a temperature of the pressurized oil stream to produce a hot oil stream;
mixing the supercritical water stream and the hot oil stream in a mixer to produce a mixed stream, where the mass flow ratio of the supercritical water stream to the hot oil stream is in the range of 0.1:1 and 10:1, where the mass ratio of metal oxide to the hot oil stream is in the range of 0.00005:1 and 0.005:1;
introducing the mixed stream to a reactor, where the reactor is operated at a temperature between 380° C. and 500° C. and a pressure between 22 MPa and 35 MPa;
processing the heavy oil in the reactor in the presence of the catalyst particles to produce a reactor effluent, where the catalyst particles catalyze upgrading reactions of the heavy oil;
reducing a temperature of the reactor effluent in a cooling unit to produce a cooled effluent;
reducing a pressure of the cooled effluent in a pressure let-down device to produce a depressurized effluent; and
separating the depressurized effluent in a separator unit to produce a product gas, a product oil, and a product water.

13. The process of claim 12, where the precursor catalyst comprises a cation and an anion.

14. The process of claim 13, wherein the cation is selected from the group consisting of transition metals from periods 4 to 6, groups 4 to 12 of the periodic table, cerium, and combinations of the same.

15. The process of claim 13, wherein the anion is selected from the group consisting of sulfates, chlorides, acetates, acetyl acetonate, formates and combinations of the same.

16. The process of claim 12, further comprising the steps of:
introducing the product oil to a distillation column;
separating the product oil in the distillation column to produce a bottom fraction and an upgraded oil product, where the bottom fraction comprises catalyst particles;
introducing the bottom fraction to a bottoms separation unit; and
separating the catalyst particles in the bottoms separation unit to produce separated catalyst and a bottoms fraction stream.

17. The process of claim 12, where an internal fluid in process lines connecting the water preheater, the mixer, and the reactor have a Reynolds number greater than 6,000.
